(19) United States
(12) Patent Application Publication
(10) Pub. No.: US 2024/0116658 A1
(43) Pub. Date: Apr. 11, 2024

(54) PROPELLER GUARD AND FLYING BODY

(71) Applicant: NIPPON TELEGRAPH AND TELEPHONE CORPORATION, Tokyo (JP)

(72) Inventors: Daisuke UCHIBORI, Tokyo (JP); Yujin HAMANO, Tokyo (JP); Kazuaki WATANABE, Tokyo (JP); Masafumi NAKAGAWA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/028,726

(22) PCT Filed: Sep. 30, 2020
(86) PCT No.: PCT/JP2020/037377

§ 371 Date: Mar. 27, 2023

(51) Int. Cl. B64U 30/299

(52) U.S. Cl. CPC B64U 30/299

(57) ABSTRACT

A propeller guard 2 includes: a propeller guard body 10 configured to surround a propeller 30 of a flight vehicle 20; and a rotating member 40 provided on a side surface of the propeller guard body 10, in which the rotating member 40 is able to rotate around at least a horizontal base axis in a case where the rotating member 40 is in contact with a vertical plane located outside the propeller guard body 10.

### TECHNICAL FIELD

The present disclosure relates to a propeller guard that protects a propeller of a flight vehicle, and a flight vehicle.

### BACKGROUND ART

In recent years, a flight vehicle (for example, a drone, a multicopter, or the like) that flies by rotation of a plurality of propellers may be used for inspection of an infrastructure structure.

In Non Patent Literature 1, a method is disclosed of using a flight vehicle for inspection of pipeline facilities buried in the ground. When the flight vehicle flies in such a space surrounded by a wall surface, if the airframe collides with an object such as the wall surface, the propeller may be damaged and the airframe may crash. Thus, a propeller guard that protects the propeller may be attached to the airframe.

In Non Patent Literature 2, a propeller guard is devised for protecting a propeller when a flight vehicle collides with an object and preventing the flight vehicle from losing a flight balance and becoming uncontrollable even when the flight vehicle collides with the object.

### CITATION LIST

### Non Patent Literature

Non Patent Literature 1: Yoshihiko Yato et al., “Development of drone capable of coping with closed space such as sewer pipeline”, 29th Trenchless Technology Conference, 2.1, 2018
Non Patent Literature 2: Noriyuki Kanehira et al., “Development of a Drone Bridge Inspection System”, Kawada Technical Report, vol. 38, 2019

### SUMMARY OF INVENTION

### Technical Problem

However, when the flight vehicle moves in the vertical direction in a space surrounded by a wall surface, in the propeller guard devised in Non Patent Literature 2, there is a possibility that the guard frame comes into contact with the wall surface or the like and the flight vehicle cannot move, or the flight vehicle loses its balance and falls.

FIG. 9 is a cross-sectional view of a manhole. As illustrated in FIG. 9, in a manhole 50, when a manhole lid installed on the ground is opened and closed, a columnar or quadrangular prism structure 51 extends in the vertical direction in the ground, and a step 52 for a worker to go down to the underground or to go up to the ground is installed in the middle. The structure 51 is, for example, a reinforced concrete pipe. A manhole lid receiving frame 53 is provided near the road surface of the manhole 50.

FIG. 10 is a diagram illustrating a problem in a case where a flight vehicle with a propeller guard moves in a space surrounded by a wall surface, such as the manhole 50. As illustrated in FIG. 10, when a flight vehicle 100 to which a propeller guard is attached is caused to ascend in the structure 51, the propeller guard may be caught by the wall surface or the like of the structure 51. In this case, there is a possibility that the flight vehicle 100 rotates in an R direction with a contact point P1 between the propeller guard and the wall surface of the structure 51 as a fulcrum, and loses its flight balance and falls. Further, the flight vehicle 100 sucks air from above the propeller and discharges the air downward to float the airframe in the air. For that reason, when flight vehicle 100 rotates in the R direction (toward the wall surface of structure 51), the propeller sucks air from above thereof, whereby there is a possibility that the flight vehicle 100 stick to the wall surface of the structure 51.

An object of the present disclosure made in view of such circumstances is to provide a propeller guard and a flight vehicle capable of suppressing occurrence of rotation of the flight vehicle due to contact with an object.

### Solution to Problem

A propeller guard according to an embodiment includes: a propeller guard body configured to surround a propeller of a flight vehicle; and a rotating member provided on a side surface of the propeller guard body, in which the rotating member is able to rotate around at least a horizontal base axis in a case where the rotating member is in contact with a vertical plane located outside the propeller guard body.

A flight vehicle according to an embodiment includes a rotating member provided on a side surface of the flight vehicle, in which the rotating member is able to rotate around at least a horizontal base axis in a case where the rotating member is in contact with a vertical plane located outside the flight vehicle.

### Advantageous Effects of Invention

According to the present disclosure, it is possible to provide a propeller guard and a flight vehicle capable of suppressing occurrence of rotation of the flight vehicle due to contact with an object.

### BRIEF DESCRIPTION OF DRAWINGS

FIG. 1 is an example of a perspective view of a flight vehicle including a propeller guard according to an embodiment.

FIG. 2 is an example of a side view of the flight vehicle including the propeller guard according to the embodiment.

FIG. 3A is an example of a perspective view of a rotating member.

FIG. 3B is an example of a perspective view of the rotating member.

FIG. 4 is a diagram illustrating a state in which the flight vehicle including the propeller guard according to the embodiment comes into contact with a wall surface during movement vertically upward.

FIG. 5 is an example of a side view of a flight vehicle including a propeller guard including a plurality of rotating members.

FIG. 6 is a diagram illustrating a state in which the flight vehicle including the propeller guard including the plurality of rotating members comes into contact with the wall surface during movement vertically upward.

FIG. 7A is an example of a side view of a propeller guard provided with a plurality of rotating members at the same position in the horizontal direction.

FIG. 7B is an example of a top view of a flight vehicle including the propeller guard provided with the plurality of rotating members at the same position in the horizontal direction.

FIG. 7C is an example of a side view of a propeller guard provided with a plurality of rotating members at the same position in the vertical direction.

FIG. 7D is an example of a side view of a flight vehicle including the propeller guard provided with the plurality of rotating members at the same position in the vertical direction.

FIG. 8 is an example of a top view of a flight vehicle including a propeller guard including a plurality of rotating members.

FIG. 9 is an example of a cross-sectional view of a manhole.

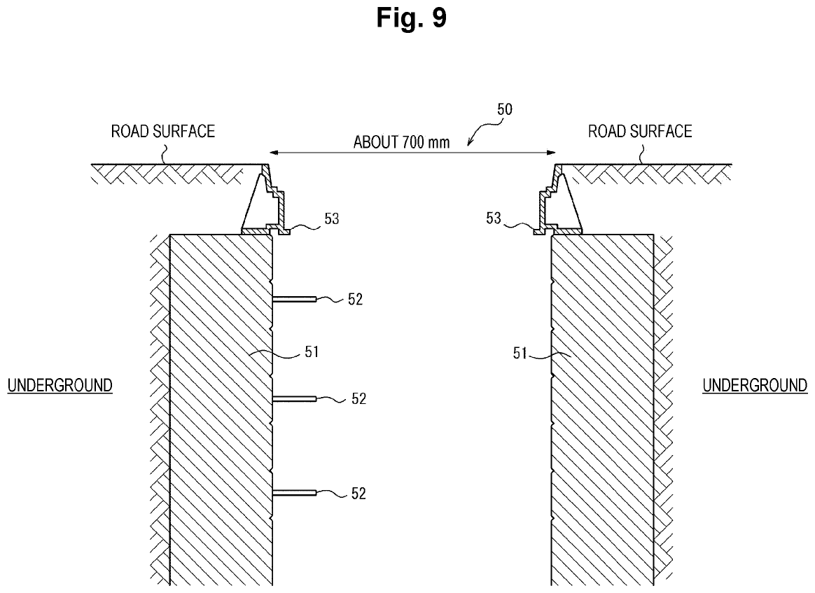

FIG. 10 is a diagram illustrating a problem of a flight vehicle with a conventional propeller guard.

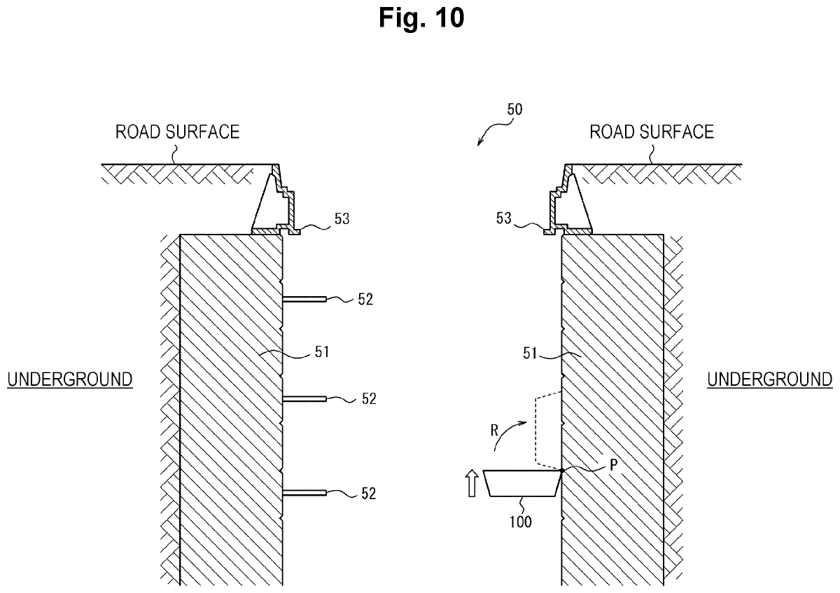

### DESCRIPTION OF EMBODIMENTS

Hereinafter, an embodiment will be described in detail with reference to the drawings. Note that the drawings are only schematically illustrated to the extent that the present invention can be sufficiently understood. Thus, the present invention is not limited only to the illustrated examples. In addition, for convenience of illustration, scales in the drawings may be different from actual scales, or may not match between the drawings.

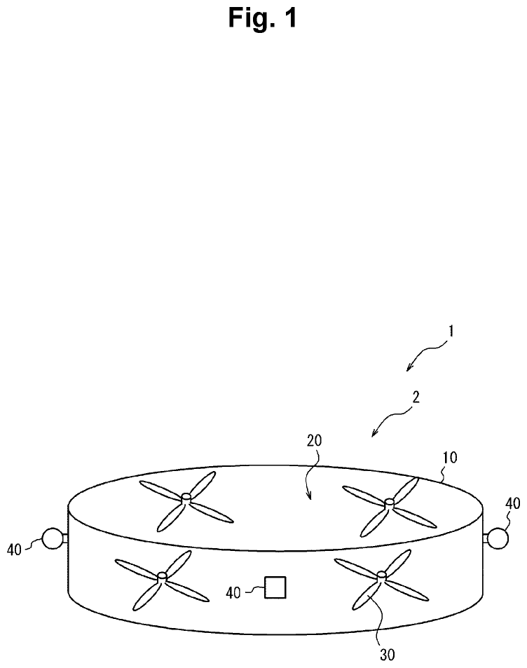

FIG. 1 is an example of a perspective view of a flight vehicle including a propeller guard according to an embodiment. A flight vehicle with a propeller guard (Hereinafter, it is simply referred to as a “flight vehicle”.) 1 illustrated in FIG. 1 includes a propeller guard body 10, a flight vehicle body 20, one or more propellers 30, and a rotating member 40. Among them, the propeller guard body 10 and the rotating member 40 constitute a propeller guard 2. The flight vehicle 1 flies by the one or more propellers 30 each having a vertical rotation axis.

The propeller guard body 10 is configured to surround the propellers 30, and protects the propellers 30. The propeller guard body 10 may be configured to surround not only the propellers 30 but also a whole of the flight vehicle body 20, or may be configured to surround a part of the flight vehicle body 20. The following drawings illustrate the propeller guard body 10 surrounding the whole of the flight vehicle body 20.

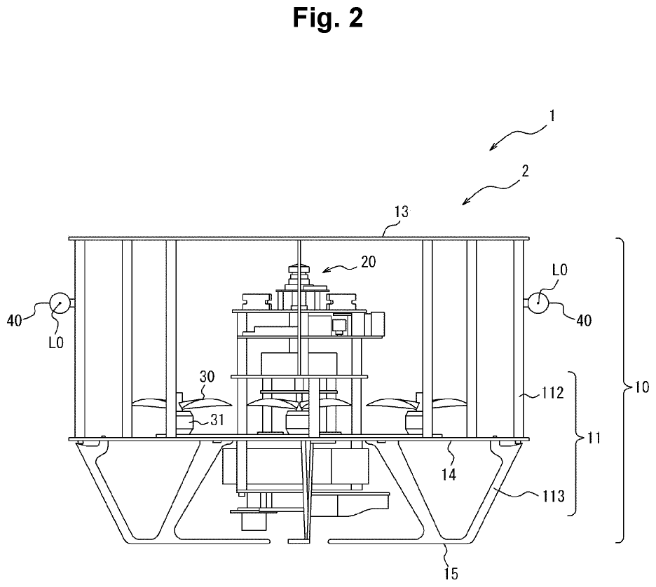

FIG. 2 is an example of a side view of the flight vehicle 1 including the propeller guard 2 according to the embodiment. The propeller guard 2 includes the propeller guard body 10 and the rotating member 40. In the example illustrated in FIG. 2, the propeller guard body 10 includes a coupling frame 11, an upper frame 13, a lower frame 14, and a base frame 15. The number of coupling frames 11 is not limited to one, and can be arbitrarily determined. Note that an intermediate frame parallel to the upper frame 13 and the lower frame 14 may be further provided between the upper frame 13 and the lower frame 14. Whether or not to provide the intermediate frame and the number of the coupling frames 11 and the intermediate frames affect strength of the propeller guard body 10 when the flight vehicle 1 comes into contact with an object. Thus, for example, in a case where it is assumed that the flight vehicle 1 is moved at a high speed, one or a plurality of the intermediate frames may be provided and the number of the coupling frames 11 may be increased to increase the strength of the propeller guard body 10.

The upper frame 13 is a frame provided on the uppermost surface of the propeller guard body 10.

The lower frame 14 is a frame provided below the upper frame 13 and substantially parallel to the upper frame 13. A motor 31 for the propeller 30 is mounted on the lower frame 14.

The base frame 15 is installed below the lower frame 14 (at the lowermost surface of the propeller guard body 10) substantially parallel to the upper frame 13, and is a frame to be in contact with an object such as the ground at the time of landing of the flight vehicle 1. The base frame 15 provides stability at the time of landing of the flight vehicle 1 and protects the bottom of the flight vehicle 1. Center points of the upper frame 13, the lower frame 14, and the base frame 15 are desirably located on a center axis of the flight vehicle body 20 to balance the flight vehicle during flight.

The coupling frame 11 is a frame that couples the upper frame 13, the lower frame 14, and the base frame 15 together. The coupling frame 11 includes a first coupling portion 112 that couples the upper frame 13 and the lower frame 14 together, and a second coupling portion 113 that couples the lower frame 14 and the base frame 15 together. In the example of FIG. 2, the upper frame 13, the lower frame 14, the base frame 15, and the coupling frame 11 constitute the propeller guard body 10 configured to surround the propellers 30 of the flight vehicle body 20. The shape of the propeller guard body 10 illustrated in FIG. 2 is an example. In addition, for simplicity of explanation, in the following embodiment, as an example, the propeller guard body 10 has an outer edge that appears circular as viewed from vertically above. However, the propeller guard body 10 can have any shape.

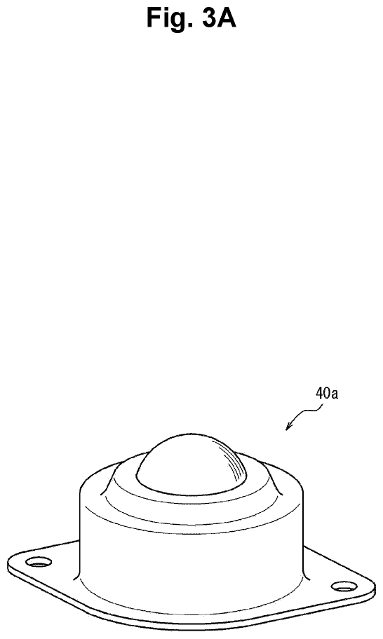

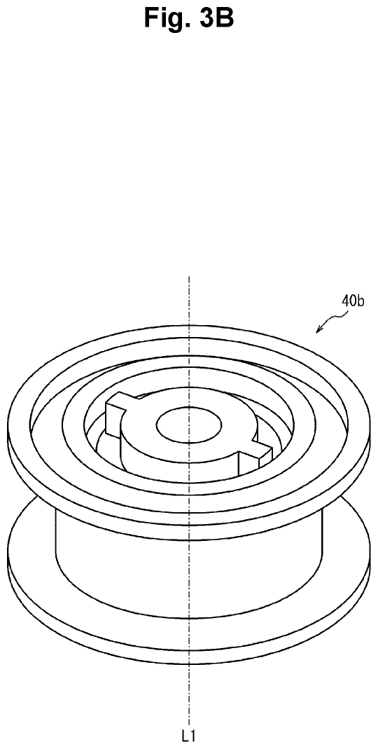

The rotating member 40 is provided on a side surface of the propeller guard body 10, and can rotate around at least a horizontal base axis L0 in the case of being in contact with the vertical plane located outside the propeller guard body 10. The base axis L0 can be, for example, a horizontal axis orthogonal to a plane including a vertical center axis of the propeller guard body 10 or the flight vehicle body 20, and the rotating member 40. FIGS. 3A and 3B illustrate examples of the rotating member 40. FIG. 3A illustrates a ball caster 40a, and can be used as the rotating member 40 that can rotate in any direction. FIG. 3B illustrates a bearing roller 40b that can rotate around a predetermined base axis L1. When the bearing roller 40b is used as the rotating member 40, the bearing roller 40b is attached to the propeller guard body 10 such that the base axis L1 is horizontal.

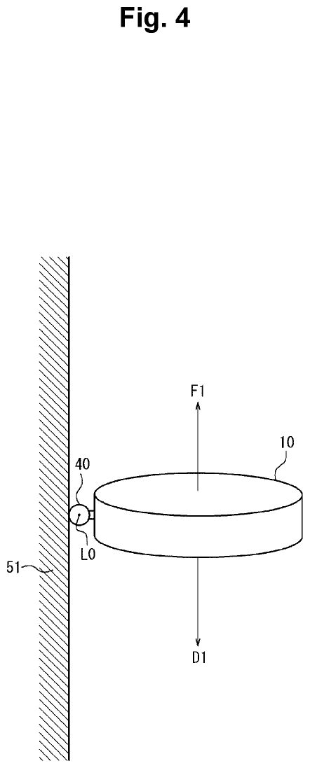

FIG. 4 illustrates a state in which the flight vehicle 1 including the propeller guard body 10 and the rotating member 40 according to the embodiment is in contact with a wall surface during movement vertically upward. As illustrated in FIG. 4, it is assumed that when the flight vehicle 1 to which the propeller guard body 10 is attached is caused to ascend in a structure 51, the flight vehicle 1 discharges air in a D1 direction and moves in an F1 direction, and the rotating member 40 comes into contact with the wall surface or the like of the structure 51. In this case, since the rotating member 40 can rotate around at least the horizontal base axis L0, it is possible to move in the vertical direction while causing the rotating member 40 to go along with the wall surface or the like of the structure 51. Thus, the flight vehicle 1 provided with the propeller guard 2 including such a rotating member 40 can prevent the propeller guard body 10 from being caught by the wall surface or the like of the structure 51, and can suppress occurrence of rotation of the flight vehicle 1 due to contact with an object.

In addition, by using a member rotatable in any direction such as the ball caster 40a as the rotating member 40, it is possible to more effectively prevent catching by a wall or the like in a case where the flight vehicle 1 comes into contact with the wall surface or the like of the structure 51. For example, when the flight vehicle 1 comes into contact with the wall surface or the like of the structure 51 while moving obliquely, the flight vehicle 1 can be moved while causing the ball caster 40a to go along with the wall surface or the like in an oblique direction, and it is possible to more effectively prevent catching. Thus, it is possible to further suppress the occurrence of rotation of the flight vehicle 1 due to contact with an object, and to effectively prevent falling and sticking to a wall due to loss of balance.

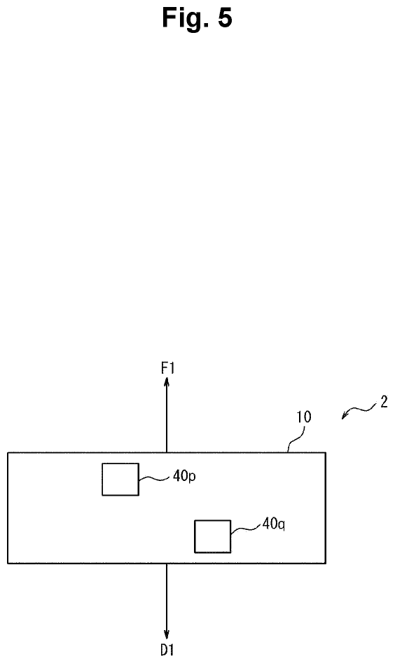

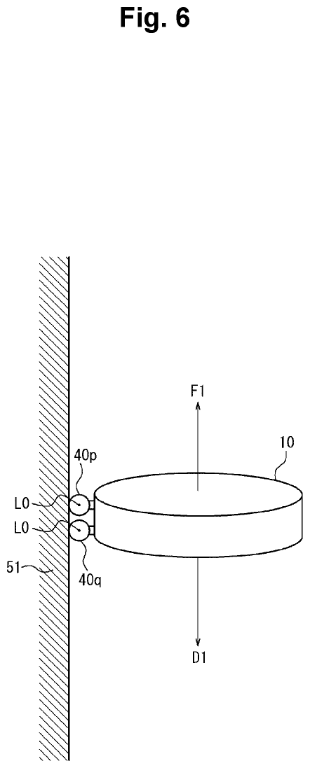

The propeller guard 2 may include a plurality of the rotating members 40. FIG. 5 is an example of a side view of the flight vehicle 1 in which a plurality of rotating members 40p and 40q is attached to the propeller guard body 10. FIG. 6 illustrates a state in which the flight vehicle 1 including the propeller guard body 10 and the plurality of rotating members 40 comes into contact with the wall surface during movement vertically upward. Since the propeller guard 2 includes the plurality of rotating members 40p and 40q, the flight vehicle 1 can more stably move while causing the rotating member 40 to go along with the wall surface or the like of the structure 51 in the case of coming into contact with the wall surface or the like of the structure 51. Thus, it is easier for the flight vehicle 1 to maintain its basic attitude, and it is possible to further suppress the occurrence of rotation of the flight vehicle 1 due to contact with an object.

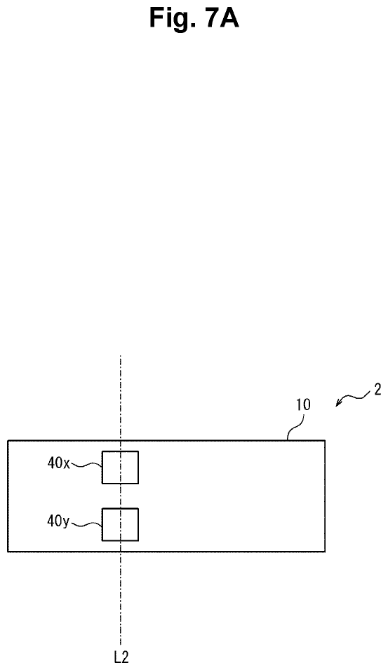

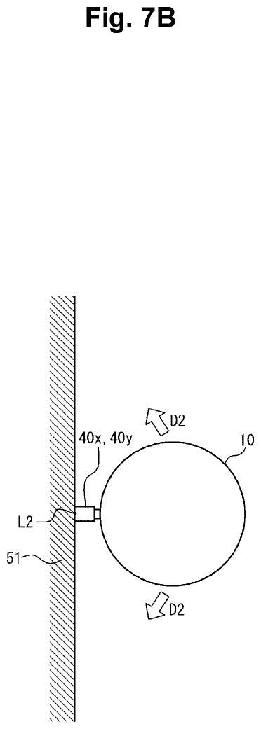

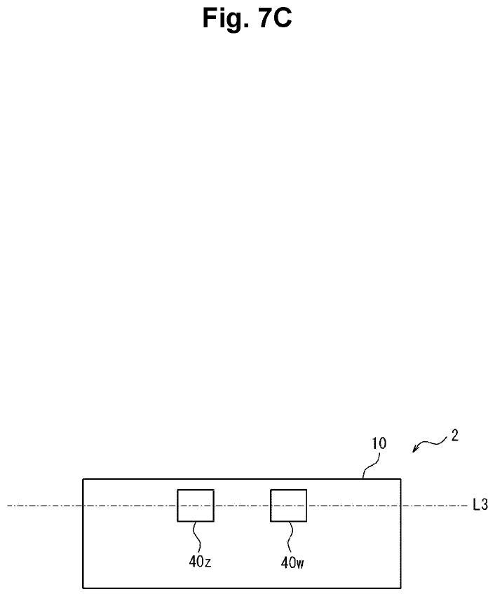

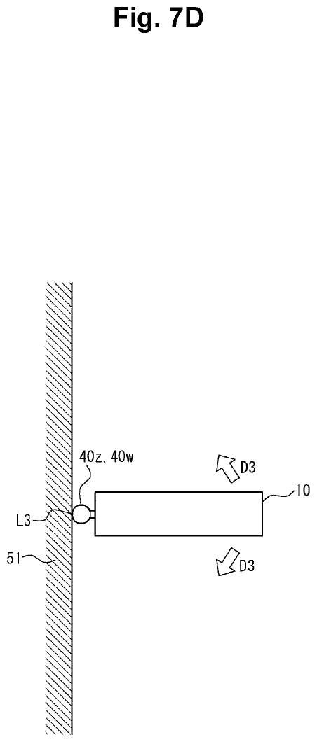

FIG. 7A is an example of a side view of the propeller guard 2 provided with a plurality of rotating members 40x and 40y at the same position in the horizontal direction. In a case where the rotating members 40x and 40y of the flight vehicle 1 including the propeller guard 2 in which the plurality of rotating members 40x and 40y is arranged on a vertical axis L2 as illustrated in FIG. 7A come into contact with a wall or the like of the structure 51, the flight vehicle 1 may rotate with the vertical axis L2 as a fulcrum. FIG. 7B is an example of a top view of the flight vehicle 1 including the propeller guard 2 provided with the plurality of rotating members 40x and 40y at the same position in the horizontal direction. As illustrated in FIG. 7B, in a case where the rotating members 40x and 40y of the flight vehicle 1 including the propeller guard 2 illustrated in FIG. 7A come into contact with the wall or the like of the structure 51, the flight vehicle 1 may rotate in a direction D2 with the vertical axis L2 as a fulcrum.

In addition, FIG. 7C is an example of a side view of the propeller guard 2 provided with a plurality of rotating members 40z and 40w at the same position in the vertical direction. In a case where the rotating members 40z and 40w of the flight vehicle 1 including the propeller guard 2 in which the plurality of rotating members 40z and 40w is arranged on a horizontal axis L3 as illustrated in FIG. 7C come into contact with the wall or the like of the structure 51, the flight vehicle 1 may rotate with the horizontal axis L3 as a fulcrum. FIG. 7D is an example of a top view of the flight vehicle 1 including the propeller guard 2 provided with the plurality of rotating members 40z and 40w at the same position in the vertical direction. As illustrated in FIG. 7D, in a case where the rotating members 40z and 40w of the flight vehicle 1 including the propeller guard 2 illustrated in FIG. 7C come into contact with the wall or the like of the structure 51, the flight vehicle 1 may rotate in a direction D3 with the horizontal axis L3 as a fulcrum.

Thus, in a case where a plurality of the rotating members 40 is provided, as illustrated in FIG. 5, the first rotating member 40p and the second rotating member 40q that can simultaneously be in contact with a plane located outside the propeller guard body 10 may have different positions in the vertical direction and in the horizontal direction. As a result, it is possible to prevent the flight vehicle 1 from rotating with the plurality of rotating members 40 simultaneously in contact with the wall surface, as a fulcrum.

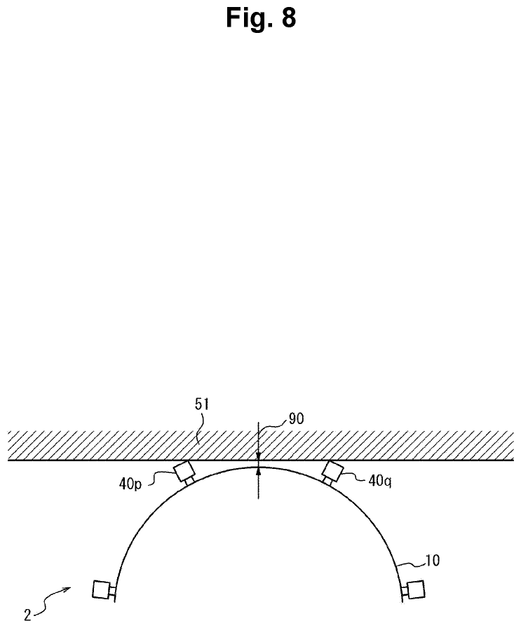

In addition, when the plurality of rotating members 40 is provided, for any two rotating members 40p and 40q provided adjacent to each other as viewed from vertically above, there may be a vertical plane located outside the propeller guard body 10 and in contact with the two rotating members 40p and 40q. FIG. 8 is a top view of such a propeller guard 2 as viewed from vertically above. In FIG. 8, the rotating member 40p and the rotating member 40q provided adjacent to each other as viewed from vertically above are in contact with the structure 51; however, since a boundary of the structure 51 is outside the propeller guard body 10, there is a gap 90 between the propeller guard body 10 and the structure 51. As described above, for any two rotating members 40p and 40q provided adjacent to each other as viewed from vertically above, there may be a vertical plane located outside the propeller guard body 10 and in contact with the two rotating members 40p and 40q. As a result, the propeller guard body 10 can be prevented from coming into direct contact with the wall or the like of the structure 51, and the occurrence of rotation of the flight vehicle 1 due to contact with an object can be further suppressed.

In addition, in the above description, an example has been described in which the propeller guard body 10 includes the rotating member 40; however, the flight vehicle 1 may include the rotating member 40. As a result, according to a principle similar to that of the propeller guard 2 described above, it is possible to move the flight vehicle 1 while causing the rotating member 40 to go along with the wall surface or the like of the structure 51, and it is possible to suppress the occurrence of rotation of the flight vehicle 1 due to contact with an object. In addition, the rotating member 40 may be provided as a component attachable to the flight vehicle body 20 or the propeller guard body 10, not in a state of being attached to the flight vehicle body 20 or the propeller guard body 10.

### REFERENCE SIGNS LIST

1 flight vehicle
2 propeller guard
10 propeller guard body
11 coupling frame
13 upper frame
14 lower frame
15 base frame
20 flight vehicle body
30 propeller
31 motor
40 rotating member
40a ball caster
40b bearing roller
50 manhole
51 structure
52 step
53 manhole lid receiving frame
112 first coupling portion
113 second coupling portion

1. A propeller guard comprising:
a propeller guard body configured to surround a propeller of a flight vehicle; and
a rotating member provided on a side surface of the propeller guard body,
wherein
the rotating member is able to rotate around at least a horizontal base axis in a case where the rotating member is in contact with a vertical plane located outside the propeller guard body.

2. The propeller guard according to claim 1, wherein the rotating member is able to rotate in any direction.

3. The propeller guard according to claim 1, comprising a plurality of rotating members.

4. The propeller guard according to claim 3, wherein for any two of the plurality of rotating members provided adjacent to each other as viewed from vertically above, there is a vertical plane located outside the propeller guard body and in contact with the two of the plurality of rotating members.

5. The propeller guard according to claim 3, wherein a first one of the plurality of rotating members and a second one of the plurality of rotating members that are simultaneously able to in contact with a plane located outside the propeller guard body are provided on a side surface of the propeller guard body such that positions in a vertical direction and positions in a horizontal direction are different from each other.

6. A flight vehicle comprising
a rotating member provided on a side surface of the flight vehicle,
wherein
the rotating member is able to rotate around at least a horizontal base axis in a case where the rotating member is in contact with a vertical plane located outside the flight vehicle.

7. The propeller guard according to claim 2, comprising a plurality of rotating members.

8. The propeller guard according to claim 4, wherein a first one of the plurality of rotating members and a second one of the plurality of rotating members that are simultaneously able to in contact with a plane located outside the propeller guard body are provided on a side surface of the propeller guard body such that positions in a vertical direction and positions in a horizontal direction are different from each other.

9. The propeller guard according to claim 7, wherein for any two of the plurality of rotating members provided adjacent to each other as viewed from vertically above, there is a vertical plane located outside the propeller guard body and in contact with the two of the plurality of rotating members.

10. The propeller guard according to claim 7, wherein a first one of the plurality of rotating members and a second one of the plurality of rotating members that are simultaneously able to in contact with a plane located outside the propeller guard body are provided on a side surface of the propeller guard body such that positions in a vertical direction and positions in a horizontal direction are different from each other.

11. The propeller guard according to claim 9, wherein a first one of the plurality of rotating members and a second one of the plurality of rotating members that are simultaneously able to in contact with a plane located outside the propeller guard body are provided on a side surface of the propeller guard body such that positions in a vertical direction and positions in a horizontal direction are different from each other.

12. The flight vehicle according to claim 6, wherein the rotating member is able to rotate in any direction.

13. The flight vehicle according to claim 6, comprising a plurality of rotating members.

14. The flight vehicle according to claim 12, comprising a plurality of rotating members.

15. The flight vehicle according to claim 13, wherein for any two of the plurality of rotating members provided adjacent to each other as viewed from vertically above, there is a vertical plane located outside a propeller guard body and in contact with the two of the plurality of rotating members, wherein the propeller guard body is configured to surround a propeller of a flight vehicle.

16. The flight vehicle according to claim 13, wherein a first one of the plurality of rotating members and a second one of the plurality of rotating members that are simultaneously able to in contact with a plane located outside a propeller guard body are provided on a side surface of the propeller guard body such that positions in a vertical direction and positions in a horizontal direction are different from each other, wherein the propeller guard body is configured to surround a propeller of a flight vehicle.

17. The flight vehicle according to claim 14, wherein for any two of the plurality of rotating members provided adjacent to each other as viewed from vertically above, there is a vertical plane located outside a propeller guard body and in contact with the two of the plurality of rotating members, wherein the propeller guard body is configured to surround a propeller of a flight vehicle.

18. The flight vehicle according to claim 14, wherein a first one of the plurality of rotating members and a second one of the plurality of rotating members that are simultaneously able to in contact with a plane located outside a propeller guard body are provided on a side surface of the propeller guard body such that positions in a vertical direction and positions in a horizontal direction are different from each other, wherein the propeller guard body is configured to surround a propeller of a flight vehicle.

19. The flight vehicle according to claim 15, wherein a first one of the plurality of rotating members and a second one of the plurality of rotating members that are simultaneously able to in contact with a plane located outside the propeller guard body are provided on a side surface of the propeller guard body such that positions in a vertical direction and positions in a horizontal direction are different from each other.

20. The flight vehicle according to claim 17, wherein a first one of the plurality of rotating members and a second one of the plurality of rotating members that are simultaneously able to in contact with a plane located outside the propeller guard body are provided on a side surface of the propeller guard body such that positions in a vertical direction and positions in a horizontal direction are different from each other.
